(19) United States
(12) Patent Application Publication
(10) Pub. No.: US 2015/0120844 A1
(43) Pub. Date: Apr. 30, 2015

(54) HIERARCHICAL RESPONSE-ENABLED NOTIFICATION SYSTEM

(71) Applicant: International Business Machines Corporation, Armonk, NY (US)

(72) Inventors: Gary B. Adler, Fort Lauderdale, FL (US); Gurmeet Arora, Plantation, FL (US); Brian R. Garrett, Tamarac, FL (US); Josh C. Holcomb, Coral Springs, FL (US)

(73) Assignee: International Business Machines Corporation, Armonk, NY (US)

(21) Appl. No.: 14/068,369

(22) Filed: Oct. 31, 2013

(51) Int. Cl. H04L 12/58

(52) U.S. Cl. CPC H04L 51/02
USPC 709/206

(57) ABSTRACT

A computer-implemented method, computer program product, and computing system are provided for providing a hierarchical response-enabled notification is described. In an implementation, a method may include identifying a notification group containing a plurality of node members. The method may also include designating a first node member as an owner of the notification group. The method may include determining a hierarchical relationship between the owner of the notification group and at least a second node member the method may include populating the notification group with at least the owner and the second node member. The method may also include receiving a notification request from the owner of the notification group. The method may include providing the notification request to at least the second node member of the notification group. The method may also include receiving a response to the notification request from the second node member of the notification group.

### TECHNICAL FIELD

The present disclosure generally relates to systems and method for hierarchical response notifications.

BACKGROUND

Many electronic communication means, such as email, instant messaging and text messaging, have been developed in recent years to accommodate users in their daily tasks. However, common communication means do not necessarily serve every communication purpose. Communication management in an organization may require that certain communications be propagated to multiple users where timely responses may be expected. Consequently, the capability to manage and compile these responses becomes exponentially more difficult the larger the pool of responders gets.

### SUMMARY OF DISCLOSURE

According to an implementation, a computer-implemented method may include identifying, by one or more processors, a notification group containing a plurality of node members. The method may also include designating a first node member as an owner of the notification group. The method may also include determining, by one or more processors, a hierarchical relationship between the owner of the notification group and at least a second node member. The method may also include populating, by one or more processors, the notification group with at least the owner and the second node member. The method may also include receiving, by one or more processors, a notification request from the owner of the notification group. The method may also include providing, by one or more processors, the notification request to at least the second node member of the notification group. The method may also include receiving, by one or more processors, a response to the notification request from the second node member of the notification group.

One or more of the following features may be included. One or more of the plurality of node members of the notification group may poll either up or down the hierarchical relationship. The response to the notification request may be at least one of a visual confirmation or rejection, a custom response and a free text response. The response to the notification request may only be seen by the node member of the notification group providing the notification request. Populating the notification group may further include allowing at least one of the plurality of node members of the notification group to invite other nodes. The response to the notification request may be allowed if received within a maximum response time delay. The notification request may be provided through at least one of mobile text messaging, instant messaging and email.

According to another implementation, a computer program product may include a computer readable medium having a plurality of instructions stored thereon. When executed by a processor, the instructions may cause the processor to perform operations including identifying a notification group containing a plurality of node members. Instructions may be included for designating a first node member as an owner of the notification group. Instructions may be included for determining a hierarchical relationship between the owner of the notification group and at least a second node member. Instructions may be included for populating the notification group with at least the owner and the second node member. Instructions may be included for receiving a notification request from the owner of the notification group. Instructions may be included for providing the notification request to at least the second node member of the notification group. Instructions may be included for receiving a response to the notification request from the second node member of the notification group.

One or more of the following features may be included. One or more of the plurality of node members of the notification group may poll either up or down the hierarchical relationship. The response to the notification request may be at least one of a visual confirmation or rejection, a custom response and a free text response. The response to the notification request may only be seen by the node member of the notification group providing the notification request. Populating the notification group may further include allowing at least one of the plurality of node members of the notification group to invite other nodes. The response to the notification request may be allowed if received within a maximum response time delay. The notification request may be provided through at least one of mobile text messaging, instant messaging and email.

According to another aspect of the disclosure, a computing system may include one or more processor devices and one or more memory architectures coupled with the one or more processor devices. The one or more processor devices may be configured to identify a notification group containing a plurality of node members. The one or more processor devices may also be configured to designate a first node member as an owner of the notification group. The one or more processor devices may also be configured to determine a hierarchical relationship between the owner of the notification group and at least a second node member. The one or more processor devices may also be configured to populate the notification group with at least the owner and the second node member. The one or more processor devices may also be configured to receive a notification request from the owner of the notification group. The one or more processor devices may also be configured to provide the notification request to at least the second node member of the notification group. The one or more processor devices may also be configured to receive a response to the notification request from the second node member of the notification group.

One or more of the following features may be included. One or more of the plurality of node members of the notification group may poll either up or down the hierarchical relationship. The response to the notification request may be at least one of a visual confirmation or rejection, a custom response and a free text response. The response to the notification request may only be seen by the node member of the notification group providing the notification request. Populating the notification group may further include allowing at least one of the plurality of node members of the notification group to invite other nodes. The response to the notification request may be allowed if received within a maximum response time delay. The notification request may be provided through at least one of mobile text messaging, instant messaging and email

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an HR process according to an implementation of the present disclosure;

FIG. 2 is a flowchart of the HR process of FIG. 1, according to an implementation of the present disclosure;

FIG. 3 is a diagrammatic representation of an example HR process of FIG. 1, according to an implementation of the present disclosure;

FIG. 4 is a diagrammatic representation of an example HR process of FIG. 1, according to an implementation of the present disclosure;

FIG. 5 is a diagrammatic view of the computing device of FIG. 1, according to an implementation of the present disclosure.

Like reference symbols in the various drawings indicate like elements.

### DETAILED DESCRIPTION

Communication management is often considered a key role of managers in their daily duties to plan, organize, and coordinate business objectives. It is often desired to communicate effectively, efficiently and simultaneously with multiple parties for a quick response. For example, in a network administration or network management scenario, being able to perform tasks on a node (e.g., such as a server on a network) requires organizing such tasks with as little disruption as possible in order not to adversely affect users that are working on that node. Such tasks are usually given to a network administrator responsible for managing maintenance activities, maintenance schedules, and notifications. Consequently, it may be useful for the administrator to be able to effectively and efficiently communicate with multiple users regarding one or more scheduled activities on a particular node. The communication may provide the users the ability to respond to the network administrator and to avoid possible unexpected interruptions.

While conference calls, e-mail and group media chats are available, they may not always be capable of quick turnaround, when a simple question or action is being posed to several users. This may especially be the case in a situation when the party initiating the activity and the affected parties are not aware of each other's identity.

In an implementation, a notification system may coordinate with social media applications, such as, but not limited to, LOTUS SAMETIME®, instant messaging applications, TWITTER®, LINKEDIN®, FACEBOOK® AND GOOGLE PLUS® to track bi-directional communications between users and coordinate responses to inquires and questions at every tier of a notification group.

A notification system may allow for two-way communication from any parent/child node in the hierarchy of a notification group. Each notification group can be treated as a separate entity that is specifically designed for one purpose (e.g. report/poll a server status/usage). However, this notification group may be built on top of an already existing user database that exists in instant messaging or other mass distribution media technologies. A notification system may allow for configuration of automated processing of bi-directional requests, freeform responses, and automated responses based on user activity (offline, away, available, do-not-disturb, etc.). The notification system may be a feature embedded with an already existing instant messaging or other mass distribution media technology.

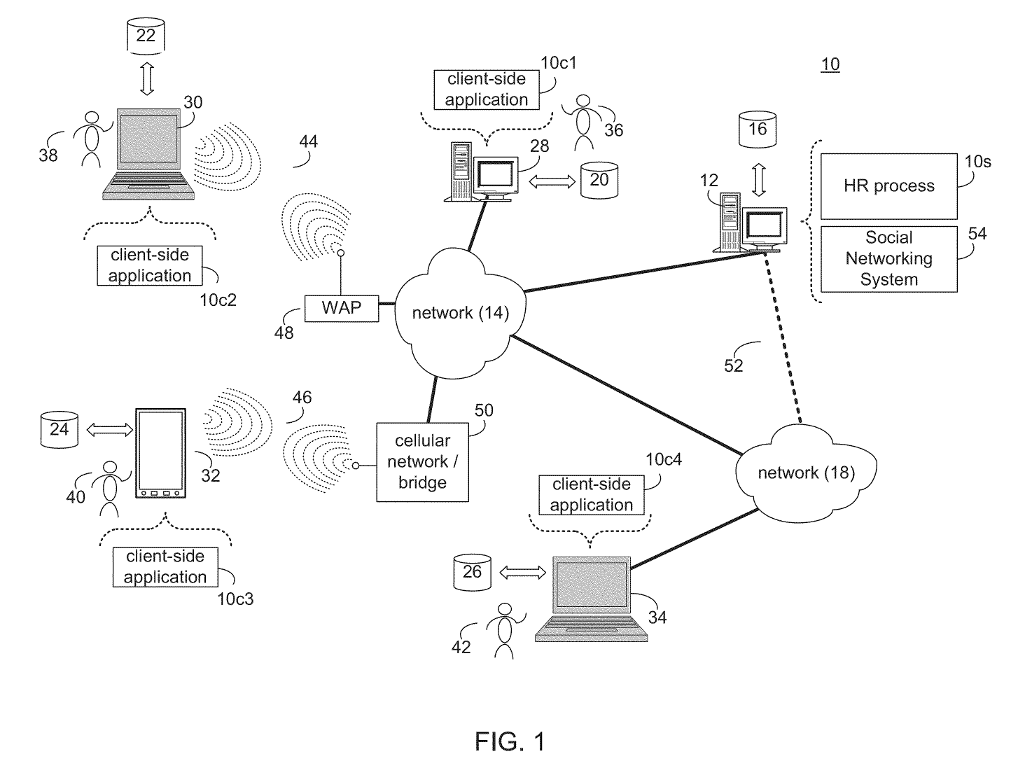

Referring to FIG. 1, there is shown a hierarchical response (HR) process 10. For the following discussion, it is intended to be understood that HR process 10 may be implemented in a variety of ways. For example, HR process 10 may be implemented as a server-side process, a client-side process, or a server-side/client-side process.

For example, HR process 10 may be implemented as a purely server-side process via HR process 10s. Alternatively, HR process 10 may be implemented as a purely client-side process via one or more of client-side application 10c1, client-side application 10c2, client-side application 10c3, and client-side application 10c4. Alternatively still, HR process 10 may be implemented as a server-side/client-side process via screen HR process 10s in combination with one or more of client-side application 10c1 , client-side application 10c2, client-side application 10c3, and client-side application 10c4. In such an example, at least a portion of the functionality of HR process 10 may be performed by HR process 10s and at least a portion of the functionality of HR process 10 may be performed by one or more of client-side application 10c1, 10c2, 10c3, and 10c3.

Accordingly, HR process 10 as used in disclosure may include any combination of HR process 10s, client-side application 10c1, client-side application 10c2, client-side application 10c3, and client-side application 10c4.

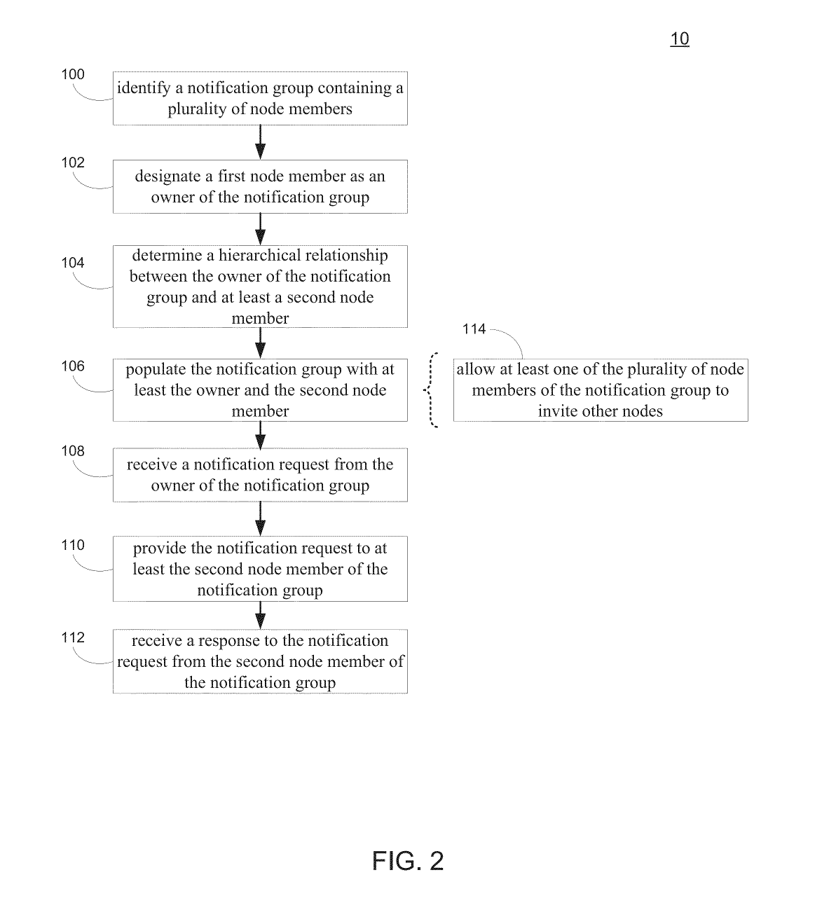

Referring also to FIG. 2, and as will be discussed in greater detail below, HR process 10 may identify 100 a notification group containing a plurality of node members. HR process 10 may also designate 102 a first node member as an owner of the notification group. HR process 10 may also determine 104 a hierarchical relationship between the owner of the notification group and at least a second node member. HR process 10 may also populate 106 the notification group with at least the owner and the second node member. HR process 10 may also receive 108 a notification request from the owner of the notification group. HR process 10 may also provide 110 the notification request to at least the second node member of the notification group. HR process 10 may also receive 112 a response to the notification request from the second node member of the notification group.

HR process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a dedicated network device.

The instruction sets and subroutines of HR process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side applications 10c1, 10c2, 10c3, 10c4 may include but are not limited to an application incorporated into and executed within a client-side process incorporated into and executed within a communication application, which may include, for example, a client-side social networking application that may, at least in part, provide communication functionality (e.g., LOTUS SAMETIME®, instant messaging applications, TWITTER®, LINKEDIN®, FACEBOOK®, and the like) or incorporated into and executed within a web browser or a specialized application (e.g., an application running on a mobile platform). The instruction sets and subroutines of client-side application 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of server-side process 10s may include but are not limited to a process incorporated into and executed within a communication application, which may include, for example, a server-side social networking application that may, in part, provide communication functionality (e.g., LOTUS SAMETIME®, instant messaging applications, TWITTER®, LINKEDIN®, FACEBOOK®, and the like). Alternatively, client-side applications 10c1-10c4 and/or server-side HR process 10 may interface with each other to allow a plurality of users (e.g., users 36, 38, 40, 42) to communicate in the social networking system via client electronic devices. Client-side applications 10c1-10c4 may access the social networking system to provide user interface and/or interaction with the social networking system.

Examples of client electronic devices 28, 30, 32, 34 may include, but are not limited to, personal computer 28, laptop computer 30, mobile computing device 32, notebook computer 34, a netbook computer (not shown), a server computer (not shown), a gaming console (not shown), a data-enabled television console (not shown), and a dedicated network device (not shown). Client electronic devices 28, 30, 32, 34 may each execute an operating system.

Users 36, 38, 40, 42 may access HR process 10 directly through network 14 or through secondary network 18. Further, screen capture process 10 may be accessed through secondary network 18 via link line 52.

The various client electronic devices (e.g., client electronic devices 28, 30, 32, 34) may be directly or indirectly coupled to network 14 (or network 18). For example, personal computer 28 is shown directly coupled to network 14. Further, laptop computer 30 is shown wirelessly coupled to network 14 via wireless communication channels 44 established between laptop computer 30 and wireless access point (WAP) 48. Similarly, mobile computing device 32 is shown wirelessly coupled to network 14 via wireless communication channel 46 established between mobile computing device 32 and cellular network/bridge 50, which is shown directly coupled to network 14. WAP 48 may be, for example, an IEEE 802.11a, 802.11b, 802.11g, 802.11n, Wi-Fi, and/or Bluetooth device that is capable of establishing wireless communication channel 46 between laptop computer 30 and WAP 48. Additionally, personal computer 34 is shown directly coupled to network 18 via a hardwired network connection.

In some embodiments, HR process 10 may communicate with, interact with, and/or include a component or module of a social networking application (e.g., social networking application 54). As may generally be understood, a social networking application (e.g., social networking application 54) may generally allow users of social networking application 54 to interact with one another via computing networks (e.g., including the forming of social connections between users and/or groups of users; sharing information, interests, media and/or other content, etc.). In some instances, interactions between users of social networking application 54 may be facilitated by user accounts associated with each respective user of social networking application 54. The user accounts may, for example, include profile information about the respective user associated with the user account. The information associated with each respective user may be maintained on and/or be accessible as one or more webpages. Social networking application 54 may also provide online communication associated with certain activities (e.g., network activities). In various embodiments, a network activity may include maintenance activity, such as, but not limited to, requests (urgent and non-urgent) for resetting a server on a customer network, bidirectional polling of user responses, and open discussions relating to nodes on customer's network.

As generally discussed above, HR process 10 may generally facilitate providing bidirectional communication between users in a computer network. In some embodiments, HR process 10 may provide for quick turnaround of responses relating to network activities when there are multiple parties being affected by these network activities.

As generally discussed above with reference to FIG. 2, HR process 10 may identify 100 a notification group containing a plurality of node members. HR process 10 may also designate 102 a first node member as an owner of the notification group. HR process 10 may also determine 104 a hierarchical relationship between the owner of the notification group and at least a second node member. HR process 10 may also populate 106 the notification group with at least the owner and the second node member. HR process 10 may also receive 108 a notification request from the owner of the notification group. HR process 10 may also provide 110 the notification request to at least the second node member of the notification group. HR process 10 may also receive 112 a response to the notification request from the second node member of the notification group.

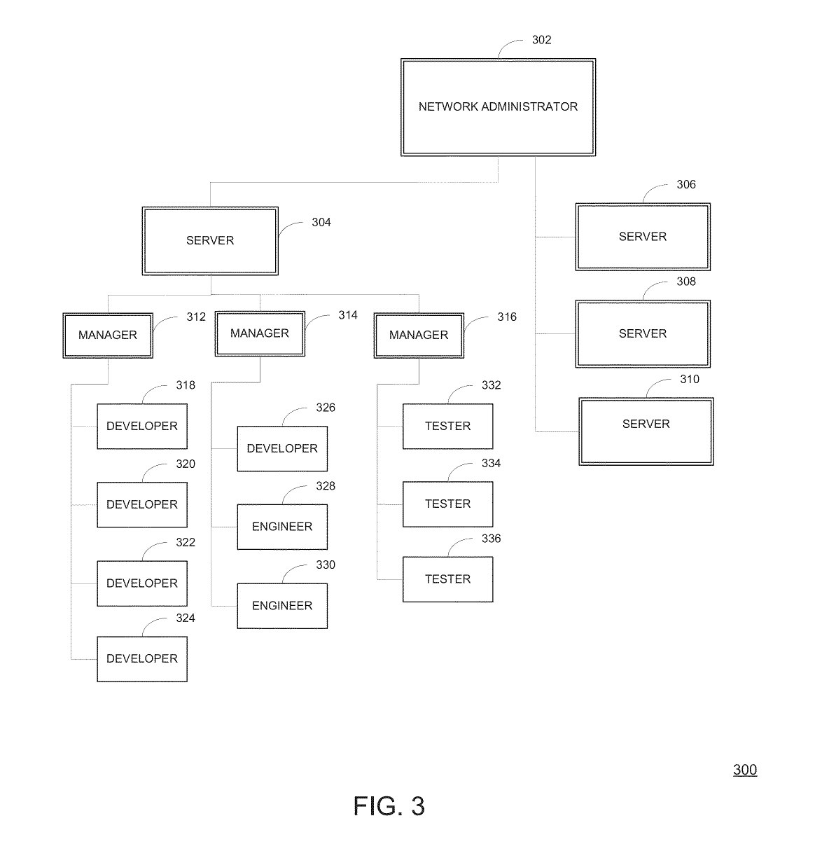

For example, and with additional reference to FIG. 3, HR process 10 may identify 100 a notification group containing a plurality of node members. For example, HR process 10, and/or another process or application, may interact with a social networking system (e.g., social networking system 54) to set up a notification group that contains a number of users that are considered as nodes on a system. HR process 10 may also be integrated inside a social networking application or program such as, LOTUS SAMETIME®, instant messaging applications, TWITTER®, LINKEDIN®, FACEBOOK®, or any other social networking application to create such a notification group that contains a plurality of node members. A node member may be a user of a computing device (e.g., a node) within a computing network. By way of illustration, a node member may be a manager, and engineer, a developer, or an employee who utilize one or more computing devices that operate over a computing network, such as a corporate computing network (e.g., which may include a LAN, a WAN, etc., or more than one computing network which may be communicatively coupled) that may, e.g., allow the node members to utilize one or more network shared resources.

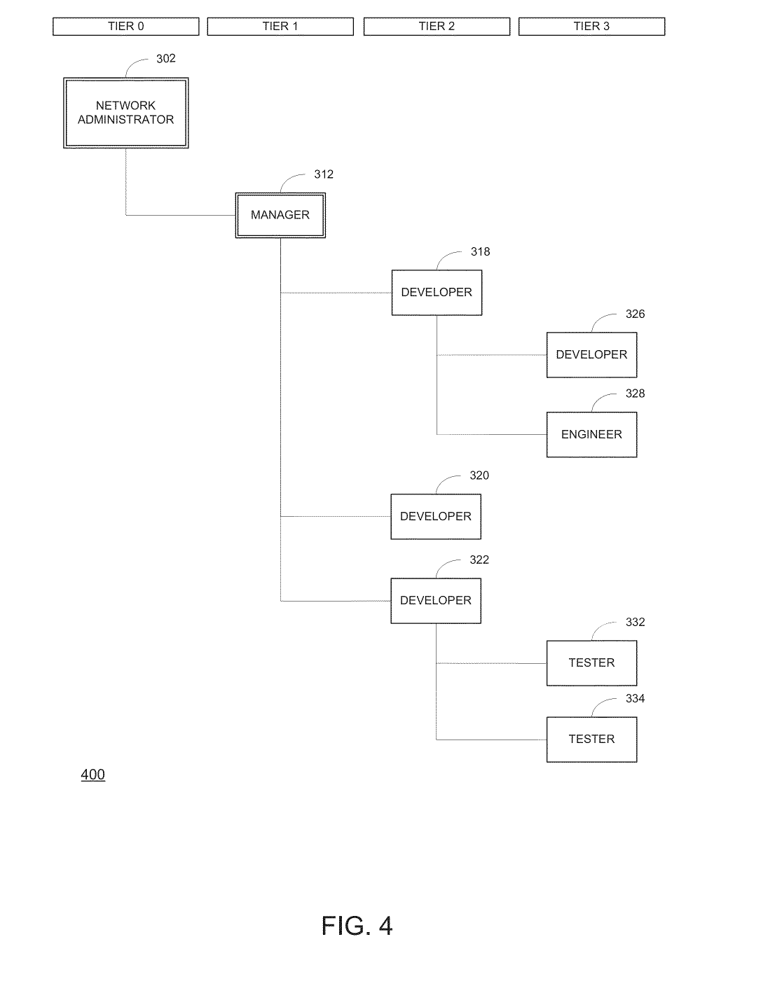

For clarification purposes, the following example will be described throughout the specification, in conjunction with FIG. 4, to show how HR process 10 may, in an exemplary embodiment, manage a notification group. Referring back to FIG. 3, an organization (e.g., organization 300) may have managers (e.g., managers, 312, 314, 316), employees, such as developers (e.g. developers 318, 320, 322, 324, 326), engineers (engineers 326, 328, 330), and testers (e.g. testers 332, 334, 336) that may have specific functions within the organization and that may be associated with each other depending on their functions within the organization. Within an organization, a number of employees may or may not report to a manager. Employees, in the illustrative examples, may be software developers, software engineers, hardware engineers, software testers, hardware testers, quality assurance engineers, or any other employee having a function in an organization.

For example, a network administrator (e.g., network administrator 302) may be responsible for a number of servers (e.g. server 304, server 306, service 308, and server 310) and may wish to set up a notification group that may include members (e.g., manager 312, manager 314, and/or manager 316), who may be linked to activities or functions related to a server (e.g. server 304). It is understood that the above are only examples of employees reporting to managers, other types of employees may report to supervisors and/or managers. Although the above shows a hierarchical relationship between employees of an organization, it should not be construed as a limitation, as other examples of hierarchical relationship may exist between other types of employees and entities.

In an embodiment, HR process 10 may identify 100 a notification group by the functions of the group members or node members. For example, a node member may be identified by their function (e.g., support manager, quality control manager, developers, engineers, or testers) in a notification group. In other words, it may not necessary to identify node members of a notification group by their name; other means of identification may be used. The above are only examples of identifying a node member of a notification group by their name or function; other means of identification may be envisioned.

HR process 10 may also designate 102 a first node member as an owner of the notification group. For example, HR process 10 may designate 102 one node member of a notification group to be responsible for identifying and/or inviting other node members to join the notification group. In the example above, since the network administrator (e.g., network administrator 302) set up the notification group, HR process 10 may designate 102 the network administrator (e.g., network administrator 302) as the owner of the notification group. The owner of the notification group may be responsible for the identification of one or more of the node members in the notification group. For example, the network administrator (e.g., network administrator 302) may wish to have specific users in an organization to be associated with one of the servers (e.g. server 304, server 306, server 308 or server 310). As will be explained in greater detail below, the owner of the notification group may share certain functions and privileges with other node members of the notification group and the owner may possess certain privileges that the other node members may not have.

Continuing with the above-stated example, HR process 10 may also determine 104 a hierarchical relationship between the owner of the notification group and at least a second node member. For example, a hierarchical relationship may exist between a network administrator (e.g., network administrator 302), a manager (manager 312, manager 314, or manager 316), and other individuals in an organization. As will be explained in greater detail below, the hierarchical relationship may be based on certain criteria that may be determined by the owner of the notification group (e.g., network administrator 302), HR process 10, and/or social networking applications.

HR process 10 may also populate 106 the notification group with at least the owner and the second node member. The network administrator (network administrator 302) may wish to have a certain number of nodes associated with a certain server. In order to achieve that, HR process 10 may populate 106 the notification group with nodes that may be associated with the server. For example, the notification group may contain an owner (e.g., network administrator 302) and node members, such as, managers (e.g., managers, 312, 314 and 316), employees reporting to such managers, such as, developers (e.g. developers 318, 320, 322, 324, 326), engineers (e.g. engineers, 328 and 330), and testers (e.g. testers 332, 334, 336). One or more of these node members, in addition to the owner of the notification group, may be associated with certain servers (e.g. servers 304, 306, 308, 310). Referring to FIG. 4, a notification group (e.g., notification group 400) may be populated by a number of users belonging to one group or belonging to other groups. For example, notification group 400 may contain developers (e.g. developers 318, 320 and 322), that report to a specific manager (e.g., manager 312), and/or may contain a developer (e.g. developer 326), an engineer (e.g. engineer 328), and testers (e.g. testers 332 and 334) that report to other managers (e.g., managers, 314 and 316) or may contain users that do not report to others. It is understood that the above are only examples of employees and other types of employees may be possible.

In one embodiment, node members may be invited to join a notification group or may be automatically added. For example, HR process 10 may populate 106 the notification group based on certain hierarchical criteria. Additionally/alternatively, the owner of the notification group (e.g., network administrator 302) may wish to invite one or more users, such as, managers or employees of an organization, to join the notification group (e.g., notification group 400). For example, a network administrator (e.g., network administrator 302) may invite another user (e.g., manager 312) to join a notification group (e.g., notification group 400) associated with a server (e.g., server 304). The network administrator (e.g., network administrator 302) may extend an invitation to other users, such as, other managers, developers, engineers and testers. Once an invitation is received by a user (e.g., manager 312), the user may accept or deny such an invitation. An acceptance may be in the form of a response that may take the form of sending an e-mail, sending a text message, or any other communication means allowing the network administrator (e.g., network administrator 302) to receive the acceptance or the denial of the invitation to join a notification group (e.g., notification group 400). In case a user (e.g., manager 312) accepts the invitation from the network administrator (e.g., network administrator 302) to join a notification group (e.g., notification group 400), the user may become a node member of the notification group (e.g., notification group 400). The node member may become a child node to the parent node (e.g., network administrator 302) that extended the invitation to the node member (e.g., manager 312). Once the manager (e.g., manager 312) becomes a node member in the notification group (e.g., notification group 400), the manager may extend an invitation to other users to join the notification group (e.g., notification group 400). In that case, the manager (e.g., manager 312) may become a parent node and users that accept the manager's invitation to join the notification group become children nodes with respect to the manager.

Populating 106 the notification group may allow 114 at least one of the plurality of node members of the notification group to invite other users to become node member of the notification group. For example, the network administrator (e.g., network administrator 302) may have sent an invitation to a developer (e.g., developer 318) to join a notification group (e.g., notification group 400). After acceptance of the invitation to join the notification group (e.g., notification group 400), the developer (e.g., developer 318) may extend an invitation to others in the organization (e.g., developer 326 and engineer 328) to join the same notification group (e.g., notification group 400). The users (e.g., developer 326 and engineer 328) may then accept or decline the invitation to join the notification group (e.g., notification group 400). In case one or all users (e.g. developer 326 and/or engineer 328) accept the invitation from the developer (e.g., developer 318), the notification group (e.g., notification group 400) may be populated with the users that accept the invitation, while preserving hierarchical characteristic. The hierarchical characteristic may include the classification of certain nodes as tiers within the hierarchy. For example, a network administrator (e.g., network administrator 302) as an owner of a notification group (e.g., notification group 400) may be considered in the hierarchical system as a tier 0, while the manager (e.g., manager 312) may be considered in the hierarchical system of notification group 400 as tier 1, and the developer (e.g., developer 318) may be considered as tier 2 in the hierarchical system of notification group 400.

HR process 10 may also receive 108 a notification request from the owner of the notification group. For example, a network administrator (e.g., network administrator 302) may wish to perform some maintenance on a server (e.g. server 304). The network administrator may want to ensure that users of that server (e.g. server 304) are not affected by such maintenance. The network administrator (e.g., network administrator 302) may poll users on that server to obtain their responses to performing such maintenance. The maintenance may be a scheduled activity, such as, upgrades, application of patches and fixes, or hardware or software replacement. The maintenance may be scheduled during a maintenance window, or during business hours. The maintenance may also be unexpected such as activities that are caused by a server malfunction. The server malfunction may be related to hardware or software issues. The above are only examples of notification requests and related purpose, other examples may exist necessitating a notification request from one node member to others in a notification group.

HR process 10 may also provide 110 the notification request to at least the second node member of the notification group. For example, and as explained in the example above, a network administrator (e.g., network administrator 302) may wish to poll users on a server (e.g., server 304). In order to achieve that, HR process 10 may provide 110 the notification request from the network administrator (e.g., network administrator 302) to other node members (e.g., manager 312, developers 318, 320, 322, 326, engineer 328 and testers 332 and 334) in a notification group (e.g., notification group 400).

A notification request may be used to poll users of a server (e.g., server 304) to provide responses to the notification request alerting the network administrator (e.g., network administrator 302) of their current activities that might postpone the maintenance activity. In another embodiment, HR process 10 may provide 110 the network administrator's notification request to a subset of node members of the notification group (e.g., notification group 400). For example, a network administrator (e.g., network administrator 302) may wish to provide a notification request for polling developers (e.g., developers 318, 320, 322 and 326). In another example, a developer (e.g., developer 318) may wish to create a notification request to poll other node members of the notification group (e.g., notification group 400), where the developer (e.g., developer 318) intends to perform certain activities, such as, application of a software patch that might impact other users on the server (e.g., server 304).

It is understood that the above are only examples of a node member of a notification group providing a notification request for polling other node members within the same notification group (e.g., notification group 400). There are other scenarios where node members of the notification group may wish to poll a subset of other node members of the notification group.

In one embodiment, one or more of the plurality of node members of the notification group may poll either up or down the hierarchical relationship. For example, node members belonging to a certain tier may poll node members within higher tiers or lower tiers in the hierarchy of the notification group. For example, a developer (e.g., developer 318), who may be classified as tier 2 in the notification group (e.g., notification group 400) may poll node members belonging to tier 0 (e.g., network administrator 302) and tier 1 (e.g., manager 312) and may poll node members belonging to tier 3 and beyond (e.g., developers 320, 322, and 326; engineer 328; testers 332 and 334). This bidirectional polling may allow node members of lower tiers to communicate with node members of higher tiers and vice versa, which would also provide a way to manage at every tier, responses (automated or otherwise) to the notification request.

In an embodiment, HR process 10 may allow the bidirectional polling to be in the form of a chat session where node members of a notification group (e.g., notification group 400) may communicate with each other in real time using chat applications. Chat applications could be programs or web applications, allowing for back-and-forth communications in real time or close to real-time. Such applications may be social networking applications such as, LOTUS SAMETIME®, instant messaging applications, TWITTER®, LINKEDIN®, FACEBOOK®, or any other social networking application or chatting applications.

The notification request may be provided through at least one of mobile text messaging, instant messaging and email. For example, the network administrator's (e.g., network administrator 302) notification request may be provided to other node members (e.g., manager 312, developers 318, 320, 322, 326, engineer 328 and testers 332 and 334) of a notification group (e.g., notification group 400) through text messaging, instant messaging, e-mail and any other communication means. It is understood that the above are only examples of communication means to deliver the notification request and should not be construed as a limitation, other communication means may be used to deliver the notification request to the node members of a notification group.

HR process 10 may also receive 112 a response to the notification request from the second node member of the notification group. Continuing with the example above, after the network administrator (e.g., network administrator 302) provided a notification request concerning certain activity on a server (e.g., server 304), the network administrator (e.g., network administrator 302) may expect node members (e.g., manager 312, developers 318, 320, 322, 326, engineer 328 and testers 332 and 334) of the notification group (e.g., notification group 400) to provide a response to the notification request. A notification group (e.g., notification group 400) may be created with characteristics that may allow node members of the notification group to see each other's responses to the notification request by a node member. In another embodiment, the notification group may not allow node members to see each other's responses to the notification request by a node member. These characteristics may be set by HR process 10 and/or by the owner of the notification group. For example, a network administrator (e.g., network administrator 302) may wish to allow the notification requests and notification responses to be visible to all or a subset of the node members (e.g., manager 312, developers 318, 320, 322, 326, engineer 328 and testers 332 and 334) of the notification group (e.g., notification group 400).

Alternatively, the network administrator (e.g., network administrator 302) and/or HR process 10 may determine that the response to the notification request may only be seen by the node member of the notification group providing the notification request. For example, if a developer (e.g., developer 318) wished to poll node members (e.g., manager 312, developers 318, 320, 322, 326, engineer 328 and testers 332 and 334) of a notification group (e.g., notification group 400) by providing a notification request to node members of the notification group, the responses coming from these node members may only be seen by the developer (e.g., developer 318), and no other node members. In another embodiment, the responses may be seen by some node members chosen at the time of the creation of the notification group or any time thereafter. For example, the notification responses may be seen by the node member of the notification group providing the notification request in addition to the owner of the notification group. The above is only an example of node members allowed to see the notification responses, other scenarios can be envisioned that allow other node members (e.g., manager 312, developers 318, 320, 322, 326, engineer 328 and testers 332 and 334) of a notification group (e.g., notification group 400) to see the notification responses.

The response to the notification request may be allowed if received within a maximum response time delay. For example, when the notification request is provided to other node members (e.g., manager 312, developers 318, 320, 322, 326, engineer 328 and testers 332 and 334) of a notification group (e.g., notification group 400), a time delay may be imposed on the delivery of responses to the notification request. This time delay may be predetermined at the time of the creation of the notification group. It may also be modified, or established, on a per notification request basis or may be determined depending on the severity of the notification request or may be determined based on the recipient node members of the notification group function. The time delay may have a maximum value, after which responses to the notification request are not allowed. For example, after a developer (e.g., developer 318) polled node members (e.g., manager 312, developers 318, 320, 322, 326, engineer 328 and testers 332 and 334) of a notification group (e.g., notification group 400), and after these node members received the notification request, one or more of these node members may not provide a response to the notification request within the maximum response time. In such a situation, the responses of one or more of these node members that did not provide a response within the maximum response time may not be received by the developer (e.g., developer 318), for example, even if the one or more node members did provide responses, but the response were provided after the maximum response time. Another embodiment, if the responses were not received within the maximum response time delay, the node member providing the notification request (e.g., developer 318), may opt to send the notification request to all node members (e.g., manager 312, developers 318, 320, 322, 326, engineer 328 and testers 332 and 334) of the notification group (e.g., notification group 400).

Although the responses to the notification request may be associated with the node member of the notification group providing the notification request, the responses may still be delivered independent of the identity of this node member. For example, and continuing with the example above where a developer (e.g., developer 318) wished to poll node members (e.g., manager 312, developers 318, 320, 322, 326, engineer 328 and testers 332 and 334) of a notification group (e.g., notification group 400), in case that developer is unavailable to receive the responses to the notification request, the responses may still be delivered to a delegate of that developer or to the manager (e.g., manager 312) of that developer (e.g., developer 318) or to a higher tier or a lower tier.

The response to the notification request may be at least one of a visual confirmation or rejection, a custom response and a free text response. For example, responses to a notification request provided by a node member (e.g., network administrator 302, manager 312, developers 318, 320, 322, 326, engineer 328 and testers 332 and 334) of a notification group (e.g., notification group 400), may be through visual confirmation, such as, checking off a box, clicking an icon, clicking a voting box or in the form of yes/no or approve/deny responses. The responses may also be configurable responses, such as, automated responses, conditional responses, custom responses, or free text responses. Automated responses may be used in scenarios where a node member is unavailable to provide a response. Conditional responses may be responses that are configurable based on the date and time the notification request was received, the type of activity, or the number of node members in a notification group. These configurable responses may be predefined at any time before or after a notification request. Custom responses may be responses that are based on the seniority level of the node member providing the notification request, or the tier level of the node member providing the notification request. Also, custom responses may be in the form of free text allowing a node member to enter a personalized response to a notification request. For example, a tester (e.g. tester 332) of a notification group (e.g., notification group 400) may wish to predefine a condition as to notification requests received outside his or her working hours or notification requests received during a vacation period. The above are only examples of configurable responses to a notification request from a node member of the notification group.

Whenever node members of a notification group receive notification requests, the responses provided by the node members may be consolidated at each parent node and each tier level of the hierarchy of the notification group. For example, in a scenario where the network administrator (e.g., network administrator 302) provided a notification request to node members (e.g., manager 312, developers 318, 320, 322, 326, engineer 328 and testers 332 and 334) of a notification group (e.g., notification group 400), the responses to the notification request may be compiled at each parent node of the notification group. For example, responses from developer 326 and engineer 328 may be received and compiled at their parent node (e.g., developer 318) in notification group 400 of FIG. 4. At that tier level (e.g., tier 2), responses from developers 318, 326 and engineer 328 may be compiled into a single response at that tier (e.g., tier 2), may be saved and presented to a higher parent node and a higher tier level as such. Further, responses from tester 332 and tester 334 may be received and compiled at their parent node (e.g., developer 322), which is at a tier 2 level in notification group 400 of FIG. 4. The consolidated response from tier 2, that is, consolidated response from developers 318 and 326 and engineer 328, response from developer 320, and consolidated response from developer 322, testers 332 and 334, may be received and compiled at tier 1 (e.g., manager 312), which in turn may be consolidated with the response from manager 312 into a single response. That single response may be received and compiled at tier 0 (e.g., network administrator 302).

Continuing with the above example, a parent node at a certain tier level of the hierarchy of the notification group may be responsible for responses received from their children nodes in lower tiers. For example, a manager (e.g., manager 312) in a notification group (e.g., notification group 400), may have a number of children nodes (e.g., developers 318, 320 and 322). Since developers 318, 320 and 322 belong to tier 2, the manager (e.g., manager 312) may be responsible for compiling the responses received from these developers (e.g., developers 318, 320 and 322). In other words, the manager (e.g., manager 312), which is at tier 1, may be responsible for compiling the responses from children nodes in a lower tier (e.g., tier 2). In the same manner, a parent node, such as a developer (e.g., developer 318), which is at a certain tier level (e.g., tier 2), may be responsible for compiling the responses from children nodes (e.g., developer 326 and engineer 328), which are at a certain tier level (e.g., tier 3).

In another embodiment, the responses received at a tier level of the hierarchy of the notification group may be automated in such a way that if a node member of that tier level is not available or uninterested in responding, an automatic response may be provided to a higher tier without necessitating a response from the node member at that tier. For example, and continuing the example above, the consolidated response from tier 2, that is, consolidated response from developers 318 and 326 and engineer 328, response from developer 320, and consolidated response from developer 322, testers 332 and 334, may bypass the response from manager 312 or manager 312 may automate his or her response in such a way that manager 312 does not have to provide a response to a notification request under certain conditions. For example, a manager (e.g., manager 312) may wish to provide either an automated response or no response in case that manager is unavailable or uninterested in responding to certain notification requests relating to maintenance activities. In that case, the consolidated responses from tier 1, where manager 312 resides, may include the responses of all the children nodes in the lower tiers, that is, consolidated response from developers 318 and 326 and engineer 328, response from developer 320, and consolidated response from developer 322, testers 332 and 334, without the inclusion of a response from manager 312. It is understood that the above is only an example, and other situations may arise where a node member may wish to automate their response to notification requests.

In another embodiment, a node member of a notification group may be unavailable to respond to a received notification request from a node member in a notification group. For example, a manager (e.g., manager 312) may be on vacation when a notification request was provided from another node member (e.g., network administrator 302, developers 318, 320, 322, 326, engineer 328, testers 332 or 334) of a notification group (e.g., notification group 400). In that case, the notification request may bypass the manager (e.g., manager 312) in order to poll the other node members (e.g., network administrator 302, developers 318, 320, 322, 326, engineer 328, testers 332 or 334) of a notification group (e.g., notification group 400). Additionally/alternatively, an automated response from the unavailable manager (e.g., manager 312), indicating that that manager is on vacation. That automated response, will be consolidated with the responses from lower tiers and presented to a higher tier. For example, the automated response from the unavailable manager (e.g., manager 312) may be consolidated with responses from children nodes, that is, consolidated response from developers 318 and 326 and engineer 328, response from developer 320, and consolidated response from developer 322, testers 332 and 334.

HR process 10 may remove node members from a notification group under certain conditions. For example, HR process 10 may determine that a node member is no longer associated with a server or no longer associated with a function. In that case, HR process 10 may remove that node member from the notification group. For example, in a notification group (e.g., notification group 400), a developer (e.g., developer 326) may have changed positions causing him or her no longer associated with the notification group (e.g., notification group 400). In another embodiment, a node member may have ceased to participate in responding to notification requests from node members of a notification group (e.g., notification group 400) or may have left the organization or may have changed functions. In that case, HR process 10 may grey-out the node member of the notification group before ultimately removing that node member from that notification group. Additionally/alternatively, HR process 10 may send inquiries and warnings indicating the possibility of removal from a notification group in case no response has been received over a predetermined time. HR process 10 may allow a user to define user preferences for the deletion of your user that may have been selected by HR process 10 for deletion from the notification group. The number and nature preferences may vary depending upon design criteria and user need.

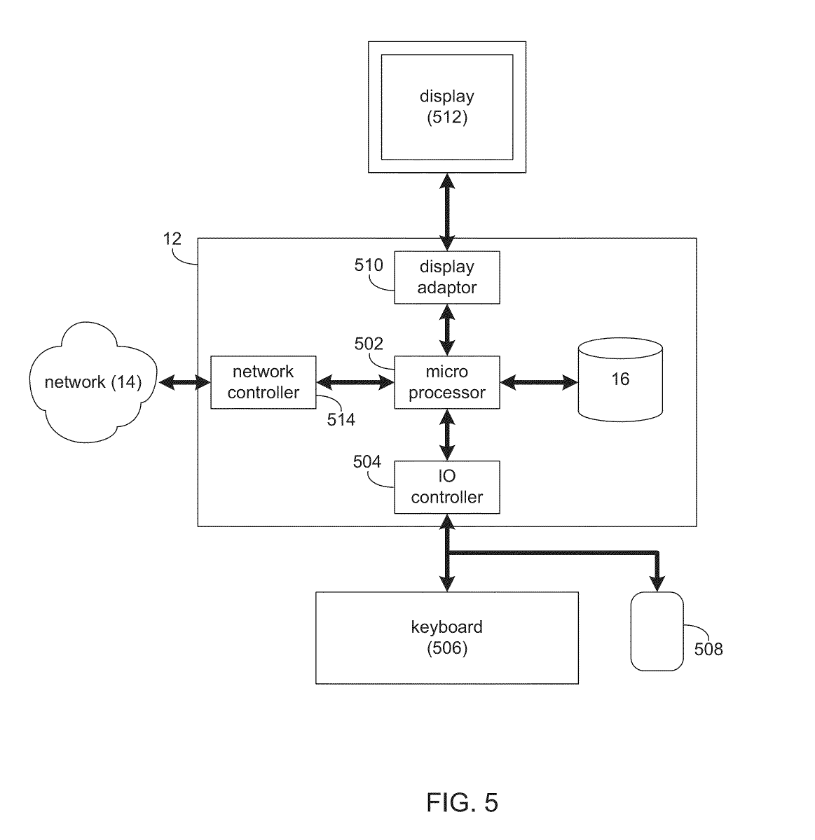

Referring also to FIG. 5, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, HR process 10 may be substituted for computing device 12 within FIG. 5, examples of which may include but are not limited to client electronic devices 28, 30, 32, 34.

Computing system 12 may include microprocessor 502 configured to e.g., process data and execute instructions/code for screen capture process 10. Microprocessor 502 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. IO controller 504 may be configured to couple Microprocessor 502 with various devices, such as keyboard 506, mouse 508, USB ports (not shown), and printer ports (not shown). Display adaptor 510 may be configured to couple display 512 (e.g., a CRT or LCD monitor) with microprocessor 502, while network adapter 514 (e.g., an Ethernet adapter) may be configured to couple Microprocessor 502 to network 14 (e.g., the Internet or a local area network).

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, C#.NET, PHP, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 502) of a general purpose computer/special purpose computer/other programmable data processing apparatus (e.g., computing device 12), such that the instructions, which execute via the processor (e.g., processor 200) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
identifying, by one or more processors, a notification group containing a plurality of node members;
designating, by the one or more processors, a first node member as an owner of the notification group;
determining, by the one or more processors, a hierarchical relationship between the owner of the notification group and at least a second node member;
populating, by the one or more processors, the notification group with at least the owner and the second node member;
receiving, by the one or more processors, a notification request from the owner of the notification group;
providing, by the one or more processors, the notification request to at least the second node member of the notification group; and
receiving, by the one or more processors, a response to the notification request from the second node member of the notification group.

2. The method of claim 1, wherein one or more of the plurality of node members of the notification group polls either up or down the hierarchical relationship.

3. The method of claim 1, wherein the response to the notification request is at least one of a visual confirmation or rejection, a custom response and a free text response.

4. The method of claim 1, wherein the response to the notification request can only be seen by the node member of the notification group providing the notification request.

5. The method of claim 1, wherein populating the notification group further includes allowing at least one of the plurality of node members of the notification group to invite other nodes.

6. The method of claim 1, wherein the response to the notification request is allowed if received within a maximum response time delay.

7. The method of claim 1, wherein the notification request is provided through at least one of mobile text messaging, instant messaging and email.

8. A computer program product comprising a computer readable medium having a plurality of instructions stored thereon, which, when executed by a processor, cause the processor to perform operations including:
identifying a notification group containing a plurality of node members;
designating a first node member as an owner of the notification group;
determining a hierarchical relationship between the owner of the notification group and at least a second node member;
populating the notification group with at least the owner and the second node member;
receiving a notification request from the owner of the notification group;
providing the notification request to at least the second node member of the notification group; and
receiving a response to the notification request from the second node member of the notification group.

9. The computer program product of claim 8, wherein one or more of the plurality of node members of the notification group polls either up or down the hierarchical relationship.

10. The computer program product of claim 8, wherein the response to the notification request is at least one of a visual confirmation or rejection, a custom response and a free text response.

11. The computer program product of claim 8, wherein the response to the notification request can only be seen by the node member of the notification group providing the notification request.

12. The computer program product of claim 8, wherein populating the notification group further includes allowing at least one of the plurality of node members of the notification group to invite other nodes.

13. The computer program product of claim 8, wherein the response to the notification request is allowed if received within a maximum response time delay.

14. The computer program product of claim 8, wherein the notification request is provided through at least one of mobile text messaging, instant messaging and email.

15. A computing system comprising:
at least one processor device, and at least one memory architecture coupled with the at least one processor; the at least one processor device configured to:
identify a notification group containing a plurality of node members;
designate a first node member as an owner of the notification group;
determine a hierarchical relationship between the owner of the notification group and at least a second node member;
populate the notification group with at least the owner and the second node member;
receive a notification request from the owner of the notification group;
provide the notification request to at least the second node member of the notification group; and
receive a response to the notification request from the second node member of the notification group.

16. The computing system of claim 15, wherein one or more of the plurality of node members of the notification group polls either up or down the hierarchical relationship.

17. The computing system of claim 15, wherein the response to the notification request is at least one of a visual confirmation or rejection, a custom response and a free text response.

18. The computing system of claim 15, wherein the response to the notification request can only be seen by the node member of the notification group providing the notification request.

19. The computing system of claim 15, wherein populating the notification group further includes allowing at least one of the plurality of node members of the notification group to invite other nodes.

20. The computing system of claim 15, wherein the response to the notification request is allowed if received within a maximum response time delay.
